(19) United States
(12) Patent Application Publication
(10) Pub. No.: US 2010/0132243 A1
(43) Pub. Date: Jun. 3, 2010

(54) NOTCHED DEHOOKING DEVICE WITH OFFSETS

(76) Inventor: Shawn Dick, Daytona Beach, FL (US)

Correspondence Address: EDWARD M. LIVINGSTON, PA, 963 TRAIL TERRACE DRIVE, NAPLES, FL, 34103, US

(21) Appl. No.: 12/326,178

(22) Filed: Dec. 2, 2008

(51) Int. Cl. A01K 97/18

(52) U.S. Cl. 43/53.5

(57) ABSTRACT

A notched dehooking device having a handle (2) located at a first end of an elongated shaft (3) and a hook removal portion (4) having a notch (6) affixed to a distal end of the shaft. The notch works to capture and hold fishing hooks while dehooking a fish. The distal end of the shaft is bent degree to 30 degrees horizontally to form a horizontal offset angle (8) and 1 degree to 30 degrees vertically to form a vertical offset angle (7). These offset angles work to better accommodate circle hooks a large range of other types and sizes of hooks and also to hide a barb or point of a hook while removing the hook thereby preventing re-engagement of a hook with a fish after being removed.

### BACKGROUND OF THE INVENTION

This invention relates to dehooking devices, specifically a dehooking device having a notch located on a hook removal portion and angle offsets for safely and effectively removing circle hooks and other hard to remove hooks from a fish's mouth.

There are many circumstances when a fisherman catches a fish and needs to safely remove a hook from the fish without causing harm to the fish. One circumstance is when a fish is caught and is too immature and small to keep. In most of these cases, fisherman are required by law to return immature fish to the water. A second circumstance is when fisherman fish using the practice of “catch and release,” wherein fish are only caught for the sport of catching the fish and the fisherman has no intention of keeping the fish. In either of these cases, the fisherman must be careful not to injure himself/herself or the fish while removing a fishing hook from the fish.

Often a fish hook is removed or dehooked from a fish with pliers. This method requires the fish to be lifted out of the water and held while the pliers are used to pry the hook out of the fish's mouth. This method puts extra stress on the fish and often tears more tissue than need be to remove the hook. In addition, this method requires that the fisherman touch the fish which could harm the fish's scales and/or fins to such an extent that the fish will not survive after being returned to the water.

Current dehooking devices available to anglers attempt to solve this problem but are not effective for removing circle hooks and other hard to remove hooks.

Thus, the need exists for a dehooking device which may be safely used to remove circle hooks or other hard to remove hook without fear of injury to the user or fish.

The relevant patents of prior art includes the following references:

| Pat./Ser. No. | Inventor | Issue/Publication Date |
|---|---|---|
| 6,840,002 | Dick | Jan. 11, 2005 |
| 6,453,601 | Duncan | Sep. 24, 2002 |
| 6,138,401 | Duncan | Oct. 31, 2000 |
| 4,914,853 | Swindle | Apr. 10, 1990 |
| 3,713,243 | Tetzner | Jan. 30, 1973 |
| 2,998,670 | Edwards | Sep. 05, 1961 |
| 2,781,599 | Steiner | Feb. 19, 1957 |
| 2,499,511 | Koger | Mar. 07, 1950 |
| 2,152,879 | Dorsey | Apr. 04, 1939 |

### SUMMARY OF THE INVENTION

The primary object of the present invention is to provide a notched dehooking device with offsets that permits a user to safely remove circle hooks and other hard to remove hooks from fish without causing any harm to fish or to the user.

The present invention fulfills the above and other objects by providing a notched dehooking device with offsets having a handle affixed to a proximal end of an elongated shaft and a spiral looped book removal portion affixed to a distal end of said shaft. A notch is located in the proximal end of the spiral looped hook removal portion. The notch works to capture and hold fishing hooks in the spiral looped hook removal portion while dehooking a fish. Another feature of the present invention is that the distal end of the shaft is bent approximately 5.3 degrees to 13 degrees horizontally and 12.2 degrees to 24 degrees vertically from the elongated shaft thereby creating vertical and horizontal offset angles. The offset angles allow the dehooking device to better accommodate circle hooks and a large range of other types and sizes of hooks. The offset angles also hide a barb or point of a hook while removing the hook thereby preventing re-engagement of a hook with a fish after being removed.

In another embodiment, a partial loop having an open section is attached to the distal end of the shaft. A notch is located in the proximal portion of the partial loop. The partial loop also has a spring-loaded gate pivotally affixed to the partial loop thereby covering the open section. The spring-loaded gate opens inward within the partial loop when pressed by a fishing line and closes after the fishes line passes, holding the fishing line within the partial loop. The distal end of the shaft may also be bent 5.3 degrees to 13 degrees horizontally and 12.2 degrees to 24 degrees vertically creating vertical and horizontal offset angles. The offset angles allow the dehooking device to better accommodate circle hooks and a large range of other types and sizes of books. The offset angles also hide a barb or point of a hook while removing the hook thereby preventing re-engagement of a hook with a fish after being removed.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a top view of a dehooking device of the present invention with a notched spiral looped hook removal portion and a distal end having offset angles;

FIG. 2 is a side view of a dehooking device of the present invention with a notched spiral looped hook removal portion and a distal end having offset angles;

FIG. 3 is a side view of a spiral looped hook removal portion of the present invention engaging a book;

FIG. 4 is a top view of an alternative embodiment of a notched dehooking device of the present invention with a notched hook removal portion and a distal end having offsets; and

FIG. 5 is a side view of an alternative embodiment of a notched dehooking device of the present invention with a notched hook removal portion and a distal end having offsets.

### DESCRIPTION OF THE PREFERRED EMBODIMENTS

For purposes of describing the preferred embodiment, the terminology used in reference to the numbered components in the drawings is as follows:
1. dehooking device
2. handle
3. shaft
4. hook removal portion
5. spiral loop
6. notch
7. vertical offset angle
8. horizontal offset angle
9. partial loop
10. gate
11. hinge pin
12. spring
13. proximal end of shaft
14. distal end of shaft
15. proximal side of hook removal portion
16. distal side of hook removal portion
17. hook
18. barb

With reference to FIG. 1 a top view of a dehooking device of the present invention with a notched spiral looped hook removal portion and a distal end having offset angles is shown. The dehooking device 1 includes an elongated shaft 3 with a handle 2 for holding the dehooking device 1 located on a proximal end 13 of the shaft 3. At a distal end 14 of the shaft 3 is a hook removal portion 4. The hook removal portion 4 has a proximal side 15 and a distal side 16 and comprises a spiral loop 5. The distal end 14 of the shaft 3 is slightly bent to create a horizontal offset angle 8 ranging from 5.3 degrees to 13 degrees but is preferably 5.3 degrees.

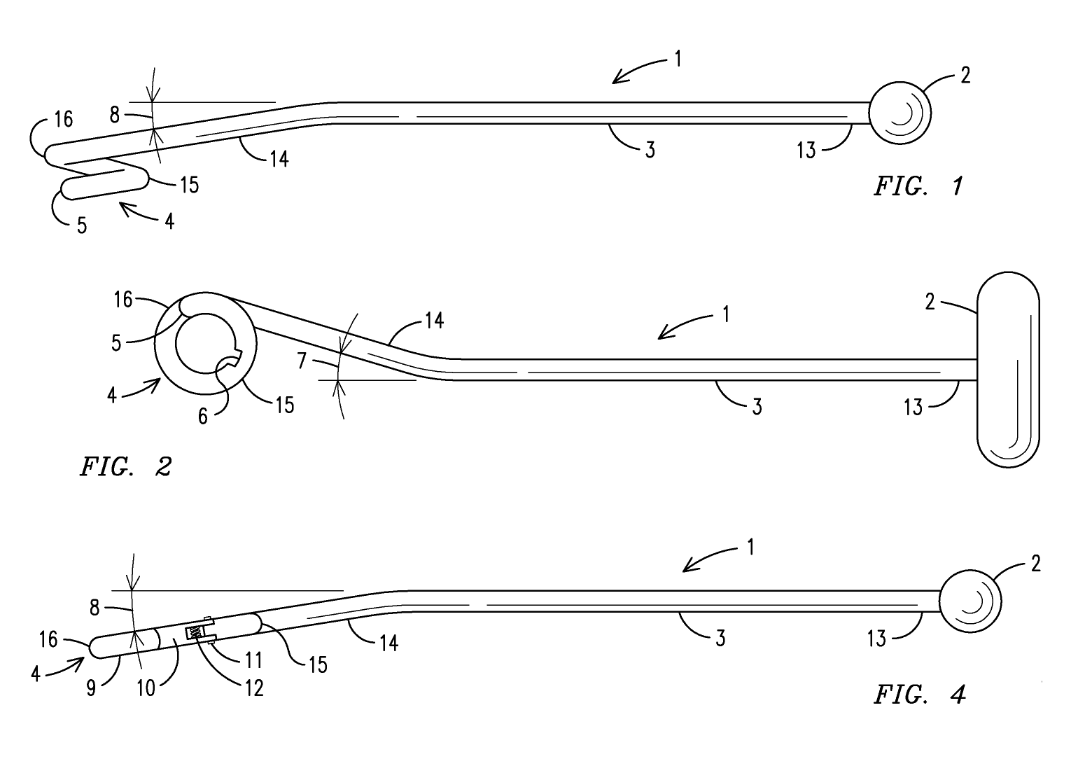

Referring to FIG. 2, a side view of a dehooking device of the present invention with a notched spiral looped hook removal portion and a distal end having offset angles is shown. The dehooking device 1 includes an elongated shaft 3 with a handle 2 for holding the dehooking device 1 located on a proximal end 13 of the shaft 3. At a distal end 14 of the shaft 3 is a hook removal portion 4. The hook removal portion 4 has a proximal side 15 and a distal side 16 and comprises a spiral loop 5. A notch 6 is located in the spiral loop on the proximal side 13 of the book removal portion 4. The distal end of the shaft 3 is slightly bent to create the vertical offset angle 7 which, along with the horizontal offset angle, allows the hook removal portion 4 to accept a large range of circle hook styles, hook sizes, hook offsets, and gaps between a shank of a hook and a barb of the hook in order the better hide a barb or point of a hook thereby preventing re-engagement of a hook with a fish after being removed. The vertical offset angle 7 is bent to create an angle ranging from 12.2 degrees to 24 degrees but is preferably 12.2 degrees.

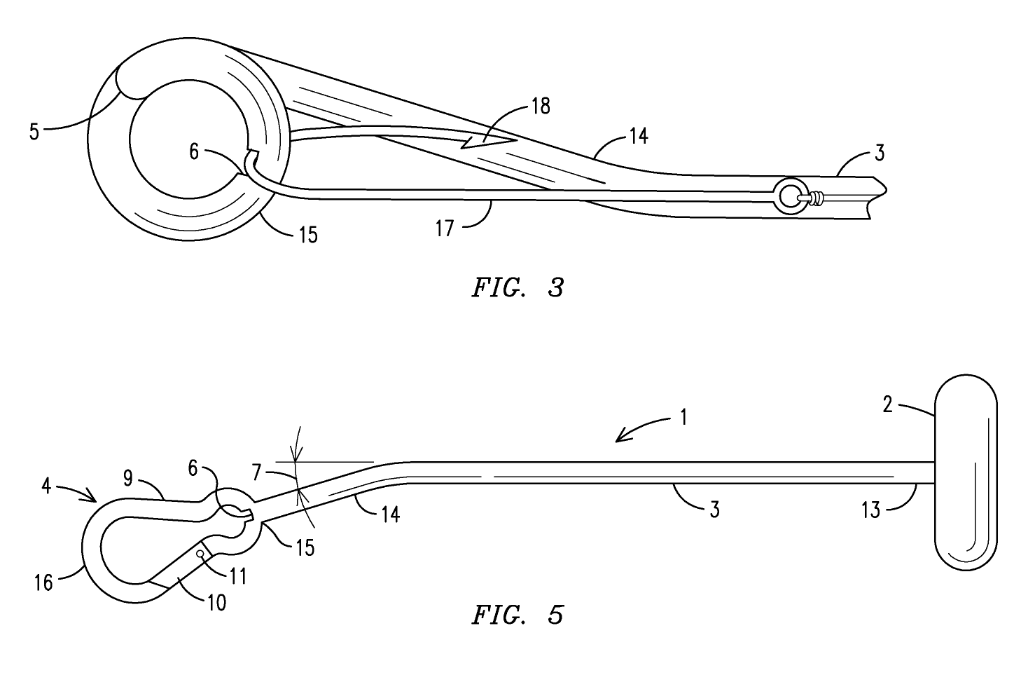

Referring to FIG. 3, a side view of a spiral looped hook removal portion of the present invention engaging a hook 17 is shown. The hook 17 is engaged in the notch 6 located on the proximal side 15 of the spiral loop 5. The hook's 17 barb 18 is shielded by the shaft 3 due to the offset angles thereby preventing re-engagement of the hook 19 with a fish after being removed.

Referring to FIG. 4, a top view of an alternative embodiment of a notched dehooking device of the present invention with a notched hook removal portion and a distal end having offsets is shown. The dehooking device 1 includes an elongated shaft 3 with a handle 2 for holding the dehooking device 1 located on a proximal end 13 of the shaft 3. At a distal end 14 of the shaft 3 is a hook removal portion 4. The hook removal portion 4 has a proximal side 15 and a distal side 16 and comprises a partial loop 9. A notch is located on the proximal side 15 of the book removal portion 4. The partial loop 9 has an open portion equipped with a gate 10. The gate 10 is hinged at one end to the partial loop 9 with a hinge pin 11. The other end of the gate 10 is held against the partial loop 9 by the force of a spring 12. The distal end 14 of the shaft 3 is slightly bent to create a horizontal offset angle 8 ranging from 5.3 degrees to 13 degrees but is preferably 5.3 degrees.

Referring to FIG. 5, a side view of an alternative embodiment of a notched dehooking device of the present invention with a notched hook removal portion and a distal end having offsets is shown. The dehooking device 1 includes an elongated shaft 3 with a handle 2 for holding the dehooking device 1 located on a proximal end 13 of the shaft 3. At a distal end 14 of the shaft 3 is a hook removal portion 4. The hook removal portion 4 has a proximal side 15 and a distal side 16 and comprises a partial loop 9. A notch 6 is located in the partial loop 9 on the proximal side 13 of the hook removal portion 4. The partial loop 9 has an open portion equipped with a gate 10. The gate 10 is hinged at one end to the partial loop 9 with a hinge pin 11. The other end of the gate 10 is held against the partial loop 9 by the force of a spring. The distal end of the shaft 3 is slightly bent to create the vertical offset angle 7 which, along with the horizontal offset angle, allows the hook removal portion 4 to accept a large range of circle hook styles, hook sizes, hook offsets, and gaps between a shank of a hook and a barb of the hook in order the better hide a barb or point of a hook thereby preventing re-engagement of a hook with a fish after being removed. The vertical offset angle 7 is bent to create an angle ranging from 12.2 degrees to 24 degrees but is preferably 12.2 degrees.

Although a preferred embodiment of a notched dehooking device with offsets has been disclosed, it should be understood, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A dehooking device comprising:
an elongated shaft;
a handle affixed to a first end of said shaft for holding said dehooking device;
a hook removal portion affixed to a distal end of said shaft for engaging and removing hooks having a distal side and a proximal side; and
a notch located on said proximal side of said hook removal portion for engaging and removing hooks.

2. The dehooking device of claim 1 wherein:
said hook removal portion is a spiral loop.

3. The dehooking device of claim 1 wherein:
said hook removal portion is a partial loop having an open section.

4. The dehooking device of claim 3 further comprising:
a gate hingedly attached at one end of said partial loop; and
a spring to hold said gate against said partial loop's other end.

5. The dehooking device of claim 4 wherein:
said gate is hingedly attached to the partial loop by a hinge pin.

6. The dehooking device of claim 1 wherein:
the distal end of said shaft is bent to form a vertical offset angle from the elongated shaft.

7. The dehooking device of claim 6 wherein:
said vertical offset angle ranges from 12.2 degrees to 24 degrees.

8. The dehooking device of claim 6 wherein:
said vertical offset angle is 12.2 degrees.

9. The dehooking device of claim 1 wherein;
the distal end of said shaft is bent to form a horizontal offset angle from the elongated shaft.

10. The dehooking device of claim 9 wherein:
said horizontal offset angle ranges from 5.3 degrees to 13 degrees.

11. The dehooking device of claim 9 wherein:
said horizontal offset angle is 5.3 degrees.

12. The dehooking device of claim 1 wherein:
said handle and shaft form a T-shape.

13. A dehooking device comprising:
an elongated shaft having a proximal end and a distal end;
a handle affixed to the proximal end of said shaft for holding the dehooking device;
a hook removal portion affixed to a distal end of said shaft comprising a spiral loop having a proximal side and a distal side;
a notch located on the hook removal portion for engaging and removing hooks
a vertical offset angle created by bending the distal end of said shaft for hiding a barb or point of a hook thereby preventing re-engagement of a hook with a fish after being removed; and
a horizontal offset angle created by bending the distal end of said shaft for hiding a barb or point of a hook while removing the thereby preventing re-engagement of the hook with a fish after being removed.

14. The dehooking device of claim 13 wherein:
said handle and shaft form a T-shape.

15. The dehooking device of claim 13 wherein;
said vertical offset angle ranges from 12.2 degrees to 24 degrees.

16. The dehooking device of claim 13 wherein:
said vertical offset angle is 12.2 degrees.

17. The dehooking device of claim 13 wherein:
said horizontal offset angle ranges from 5.3 degrees to 13 degrees.

18. The dehooking device of claim 13 wherein:
said horizontal offset angle is 5.3 degrees.

19. The dehooking device of claim 13 wherein:
said notch is located on the proximal portion of the hook removal portion.

20. A dehooking device comprising:
an elongated shaft having a proximal end and a distal end;
a handle affixed to the proximal end of said shaft for holding said dehooking device;
a hook removal portion affixed to the distal end of said shaft having a proximal side and a distal side and comprising a partial loop having an open sections a gate hingedly attached at one end of said partial loop and a spring to hold said gate against said partial loop's other end;
a notch located the hook removal portion for engaging and removing hooks;
a vertical offset angle created by bending the distal end of said shaft for hiding a barb or point of a hook while removing the hook thereby preventing re-engagement of the hook with a fish after being removed; and
a horizontal offset angle created by bending the distal end of said shaft for hiding a barb or point of a hook thereby preventing re-engagement of a hook with a fish after being removed.

21. The dehooking device of claim 20 wherein:
said handle and shaft form a T-shape.

22. The dehooking device of claim 20 wherein:
said vertical offset angle ranges from 12.2 degrees to 24 degrees.

23. The dehooking device of claim 20 wherein:
said vertical offset angle is 12.2 degrees.

24. The dehooking device of claim 20 wherein:
said horizontal offset angle ranges from 5.3 degrees to 13 degrees.

25. The dehooking device of claim 20 wherein;
said horizontal offset angle is 5.3 degrees

26. The dehooking device of claim 20 wherein:
said notch is located on the proximal side of said hook removal portion.

27. The dehooking device of claim 20 wherein:
said gate is hingedly attached to the partial loop by a hinge pin.
